(19) United States
(12) Patent Application Publication
(10) Pub. No.: US 2025/0334867 A1
(43) Pub. Date: Oct. 30, 2025

(54) VAPOR CHAMBER, COOLING DEVICE, ELECTRONIC DEVICE, WAVELENGTH CONVERSION DEVICE, AND PROJECTOR

(71) Applicant: SEIKO EPSON CORPORATION, Tokyo (JP)

(72) Inventors: Naoya SHINDO, AZUMINO-SHI (JP); Masato KADOTANI, MATSUMOTO-SHI (JP)

(21) Appl. No.: 19/188,510

(22) Filed: Apr. 24, 2025

(30) Foreign Application Priority Data
Apr. 24, 2024 (JP) 2024-070938

(51) Int. Cl. G03B 21/16; G03B 21/20

(52) U.S. Cl. CPC G03B 21/16; G03B 21/204

(57) ABSTRACT

The vapor chamber includes a thermally conductive first substrate with a placement region for a heat-generating body; a thermally conductive second substrate facing the first substrate, an accommodation chamber having an accommodation space formed by bonding a peripheral edge of a first substrate and a peripheral edge of a second substrate; a working medium accommodated in the accommodation chamber, which is transitioned into a gas phase and a liquid phase by heat, and a plurality of pillars arranged between the first inner surface of the first substrate and the second inner surface of the second substrate in the accommodation chamber, wherein the first substrate has the first surface opposite to the second substrate and, a recessed section recessed from the first surface, the thickness dimension of the first substrate at the bottom section of the recessed section is smaller than the thickness dimension of the entire first substrate, and the placement region is located at the bottom section of the recessed section.

The present application is based on, and claims priority from JP Application Serial Number 2024-070938, filed Apr. 24, 2024, the disclosure of which is hereby incorporated by reference herein in its entirety.

### BACKGROUND

### 1. Technical Field

The present disclosure relates to a vapor chamber, a cooling device, an electronic device, a wavelength conversion device, and a projector.

### 2. Related Art

In the related art, a cooling mechanism for cooling a light source unit including a plurality of light emitting elements that emit light is known (see, for example, JP-A-2019-128465).

The cooling mechanism disclosed in JP-A-2019-128465 includes a heat receiver plate, a heat diffusion member, a heat radiation fin, and a cooling fan. The light source unit is fixed to the heat receiver plate. The heat diffusion member is a vapor chamber. The heat diffusion member is inserted into the opening section of the heat receiver plate and has a protruding portion that comes into contact with a base member that holds the plurality of light emitting elements in the light source unit. The heat radiation fin is fixed to the heat diffusion member, and an airflow is circulated through the plurality of fins of the heat radiation fin by the cooling fan.

On the other hand, a vapor chamber in which a plurality of pillar sections is provided is known (for example, see JP-A-2022-63805).

The vapor chamber described in JP-A-2022-63805 includes a housing having an internal space formed by a first metal plate and a second metal plate that are joined to each other so as to face each other. In the internal space, a wick structure and a working medium are housed, and a plurality of pillar sections are arranged. The plurality of pillar sections protrudes from the second metal plate toward the first metal plate. The plurality of pillar sections are in contact with the wick structure or in contact with the first metal plate via a through hole provided in the wick structure to support the first metal plate. In the vapor chamber described in JP-A-2022-63805, when an external force acts on the outer surface of the housing, the plurality of pillar sections suppresses the deformation of the housing and prevent the internal space from narrowing.

In the cooling mechanism described in JP-A-2019-128465, the heat diffusion member is in contact with a base member of a light source unit, which is a heat source, at the protruding portion. Therefore, the efficiency of heat transfer from the base member to the heat diffusion member is low. On the other hand, bonding the heat source and the vapor chamber to efficiently transfer heat from the heat source to the vapor chamber is considered.

However, due to a high temperature when the heat source is bonded to the vapor chamber, the internal pressure of the vapor chamber increases, and an expansion force acts on the vapor chamber. On the other hand, as in a vapor chamber described in JP-A-2022-63805, a plurality of pillar sections may be provided inside the vapor chamber.

However, there is a problem in that the expansion force easily exceeds the bonding limit of the plurality of pillar sections between the first substrate and the second substrate in a portion where the temperature locally increases, such as a portion where the heat source is bonded, and the vapor chamber easily expands.

On the other hand, it is conceivable to increase the pressure resistance of the vapor chamber by increasing the number of pillar sections. However, if the number of pillar sections to be installed is increased as a whole, the internal space is narrowed, and the working medium is less likely to flow, which causes a problem of a decrease in the cooling performance of the vapor chamber.

For these reasons, a configuration of a vapor chamber capable of improving pressure resistance and cooling performance has been desired.

### SUMMARY

A vapor chamber according to a first aspect of the present disclosure includes:
a thermally conductive first substrate with a placement region for a heat-generating body;
a thermally conductive second substrate facing the first substrate; an accommodation chamber having an accommodation space formed by bonding a peripheral edge of the first substrate and a peripheral edge of the second substrate;
a working medium accommodated in the accommodation chamber and transitioning between a gas phase and a liquid phase by heating; and
a plurality of pillars arranged between a first inner surface of the first substrate and a second inner surface of the second substrate in the accommodation chamber, wherein
the first substrate has a first surface on a side opposite to the second substrate and, a recessed section recessed from the first surface, a thickness dimension of the first substrate at a bottom section of the recessed section is smaller than a thickness dimension of the entire first substrate, and the placement region is located at the bottom section of the recessed section.

A cooling device according to a second aspect of the present disclosure includes
the vapor chamber according to the first aspect and the heat-generating body bonded to the placement region.

An electronic device according to a third aspect of the present disclosure includes
the cooling device according to the second aspect.

A wavelength conversion device according to a fourth aspect of the present disclosure includes
the cooling device according to the second aspect wherein
the heat-generating body is a fluorescent substance that converts the wavelength of incident excitation light and emits fluorescence and the fluorescent substance is bonded to the placement region using heat conductive bonding materials.

A projector according to a fifth aspect of the present disclosure includes
a light source;
the wavelength conversion device, according to the fourth aspect, onto which light from the light source as the excitation light is incident;
an image forming device that creates image light from light including the fluorescence emitted by the fluorescent substance; and
a projection optical device that projects the image light.

### BRIEF DESCRIPTION OF THE DRAWINGS

FIG. 1 is a schematic view showing configuration of a projector according to a first embodiment.

FIG. 2 is a schematic view showing configuration of a light source device in the first embodiment.

FIG. 3 is a perspective view showing the wavelength conversion device in the first embodiment.

FIG. 4 is an exploded perspective view showing the wavelength conversion device according to the first embodiment.

FIG. 5 is a view showing an internal structure of the vapor chamber according to the first embodiment.

FIG. 6 is a view showing the vapor chamber with the second substrate removed according to the first embodiment.

FIG. 7 is a cross-sectional view showing a first modification of the vapor chamber according to the first embodiment.

FIG. 8 is a cross-sectional view showing a second modification of the vapor chamber according to the first embodiment.

FIG. 9 is a view showing a third modification of the vapor chamber according to the first embodiment.

FIG. 10 is a view showing the internal structure of the vapor chamber of the wavelength conversion device included in the projector according to the second embodiment.

FIG. 11 is a view showing the internal structure of the vapor chamber of the wavelength conversion device included in the projector according to the third embodiment.

### DESCRIPTION OF EMBODIMENTS

### First Embodiment

Hereinafter, a first embodiment of the present disclosure will be described with reference to the drawings.

### Schematic Configuration of Projector

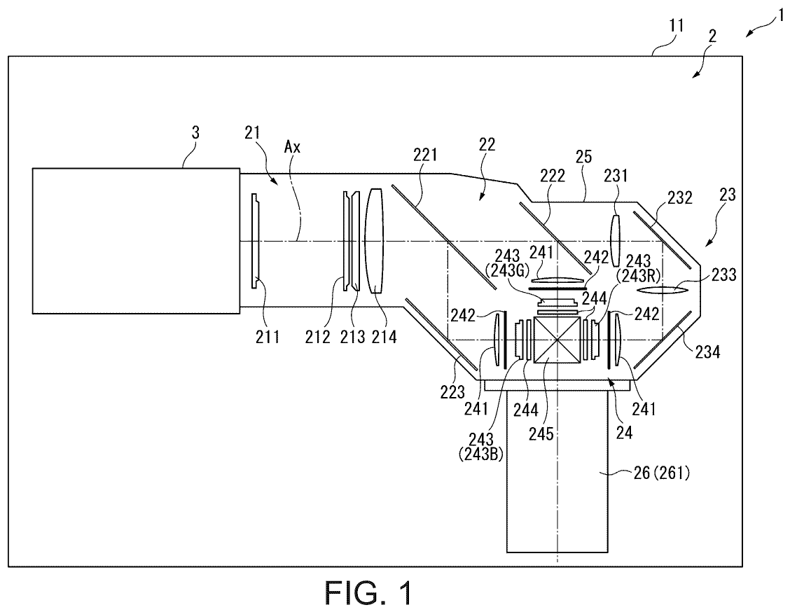

FIG. 1 is a schematic view showing configuration of a projector 1 according to a present embodiment.

The projector 1 according to the present embodiment is an electronic device that projects image light corresponding to image information. As shown in FIG. 1, the projector 1 includes an exterior housing 11 and an image projection device 2 housed in the exterior housing 11. In addition, although not shown, the projector 1 includes a control device that controls the operation of the projector 1 and a power supply device that supplies electric power to the electronic components of the projector 1.

### Configuration of Image Projection Device

The image projection device 2 projects image light corresponding to the input image information. The image projection device 2 includes a light source device 3, a homogenization optics system 21, a color separation optics system 22, a relay optics system 23, an image forming device 24, an optical enclosure 25, and a projection optical device 26.

The light source device 3 emits illumination light to the homogenization optics system 21. The configuration of the light source device 3 will be described in detail later.

The homogenization optics system 21 homogenizes the illumination light emitted from the light source device 3. The homogenized illumination light passes through the color separation optics system 22 and the relay optics system 23 and illuminates a modulation region of an optical modulation element 243 (to be described later). The homogenization optics system 21 includes lens arrays 211 and 212, a polarization conversion element 213, and a superimposing lens 214.

The color separation optics system 22 separates the illumination light incident from the homogenization optics system 21 into red, green, and blue light. The color separation optics system 22 includes dichroic mirrors 221 and 222 and a reflective mirror 223 that reflects the blue light separated by the dichroic mirror 221.

The relay optics system 23 is provided in the optical path of the red light, which is longer than the optical paths of the other color lights and suppresses the loss of the red light. The relay optics system 23 includes an incident side lens 231, a relay lens 233, and reflective mirrors 232 and 234. In the present embodiment, the red light is guided to the relay optics system 23. However, the present disclosure is not limited to this, and for example, color light having a longer optical path than the other color light may be blue light, and the blue light may be guided to the relay optics system 23.

The image forming device 24 modulates red, green, and blue color lights emitted from the light source device 3 and separated from each other and combines the modulated color lights to form image light. That is, the image forming device 24 forms the image light from the light including the fluorescence emitted from a fluorescent substance 41 of a wavelength conversion device 4A constituting the light source device 3. The image forming device 24 includes three field lenses 241, three incident side polarizing plates 242, three optical modulation elements 243, three exit side polarizing plates 244, and one color combining optical system 245, which are provided in accordance with the incident color light.

The optical modulation element 243 modulates the light from the light source device 3 to form the image light. Specifically, the optical modulation element 243 modulates the color light incident from the incident side polarizing plate 242 according to the image signal and emits the modulated color light. The three optical modulation elements 243 include the optical modulation element 243R for modulating red color light, the optical modulation element 243G for modulating green color light, and the optical modulation element 243B for modulating blue light. As the optical modulation element 243, a transmissive liquid crystal panel can be exemplified.

The color combining optical system 245 combines the three color lights modulated by the optical modulation elements 243R, 243G, and 243B and incident from the respective exit side polarizing plates 244. The image light combined by the color combining optical system 245 is incident on the projection optical device 26. In the present embodiment, the color combining optical system 245 is constituted by a substantially rectangular parallelepiped cross dichroic prism, but it may be constituted by a plurality of dichroic mirrors.

The optical enclosure 25 accommodates the homogenization optics system 21, the color separation optics system 22, the relay optics system 23, and the image forming device 24 therein. In the image projection device 2, an optical axis Ax is set by design, and the optical enclosure 25 holds the homogenization optics system 21, the color separation optics system 22, the relay optics system 23, and the image forming device 24 at predetermined positions on the optical axis Ax. The light source device 3 and the projection optical device 26 are arranged at predetermined positions on the optical axis Ax.

The projection optical device 26 projects image light incident from the image forming device 24 onto a projected surface such as a screen. That is, the projection optical device 26 projects the image light formed by the image forming device 24. The projection optical device 26 may be, for example, a lens assembly including a plurality of lenses (not shown) and a lens barrel 261 that houses the plurality of lenses.

### Configuration of the Light Source Device

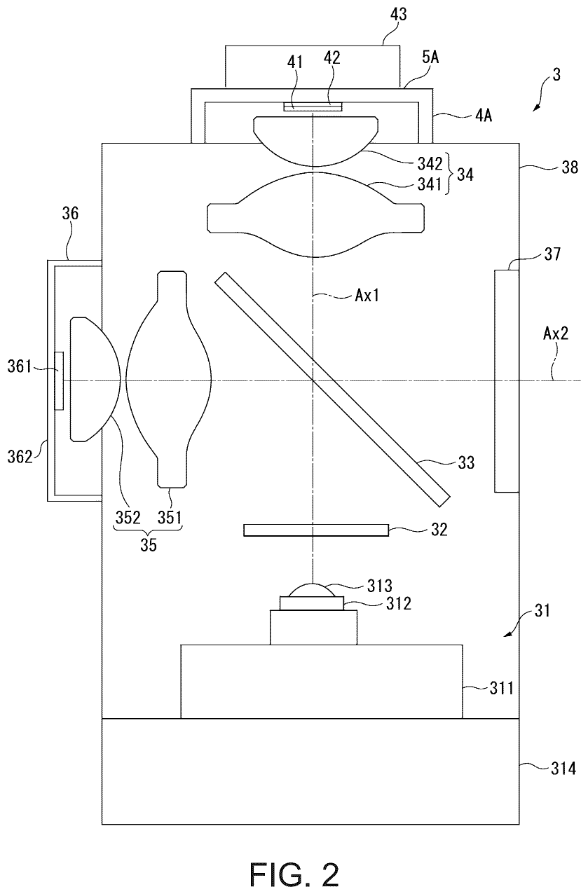

FIG. 2 is a schematic view showing the configuration of the light source device 3.

The light source device 3 emits illumination light for illuminating the modulation region of each optical modulation element 243 to the homogenization optics system 21. As shown in FIG. 2, the light source device 3 includes a light source 31, a diffuse transmission section 32, an optical separation section 33, a first optical condensing element 34, the wavelength conversion device 4A, a second optical condensing element 35, a diffuse reflection element 36, a phase difference section 37, and a support member 38 that supports these components.

In the light source device 3, the illumination optical axes Ax1 and Ax2 are set to intersect each other.

The light source 31, the diffuse transmission section 32, the optical separation section 33, the first optical condensing element 34, and the wavelength conversion device 4A are arranged on the illumination optical axis Ax1.

The optical separation section 33, the second optical condensing element 35, the diffuse reflection element 36, and the phase difference section 37 are arranged on the illumination optical axis Ax2. The optical separation section 33 is arranged at the intersection of the illumination optical axis Ax1 and the illumination optical axis Ax2.

The illumination optical axis Ax2 coincides with the optical axis Ax at the position of the lens array 211. In other words, the illumination optical axis Ax2 is set on an extension line of the optical axis Ax.

The light source 31 includes a substrate 311, a light emitting element 312, a collimator lens 313, and a heat radiation member 314.

The substrate 311 supports the light emitting element 312 and the collimator lens 313.

The light emitting element 312 emits light. Although not shown, the light emitting element 312 is composed of a plurality of semiconductor lasers that emit blue light. The light emitting element 312 and the substrate 311 are one of the heat-generating bodies that generate heat when the light source 31 is turned on.

The collimator lens 313 collimates the light emitted from the light emitting element 312.

The heat radiation member 314 is coupled in a heat transferable manner to a surface of the substrate 311 on the opposite side of the surface on which the light emitting element 312 and the collimator lens 313 are arranged. The heat radiation member 314 is cooled by a cooling gas sent from a fan (not shown), and thus the light source 31 is cooled.

The diffuse transmission section 32 diffuses the light incident from the light source 31 and homogenizes the illuminance distribution of the emitted light. Examples of the diffuse transmission section 32 include a configuration having a hologram, a configuration in which a plurality of small lenses are arranged on a plane orthogonal to the optical axis, and a configuration in which a surface through which light passes is a rough surface.

Instead of the diffuse transmission section 32, a homogenizer optical element with a pair of multi-lens arrays may be used in the light source device 3. On the other hand, in the case where the diffuse transmission section 32 is adopted, the distance from the light source 31 to the optical separation section 33 can be shortened as compared with the case where a homogenizer optical element is adopted. The light emitted from the diffuse transmission section 32 is incident on the optical separation section 33.

The optical separation section 33 has a function of a half mirror that transmits a part of the light incident via the diffuse transmission section 32 from the light source 31 and reflects the other light. The optical separation section 33 has a function of a dichroic mirror that transmits the blue light incident from the diffuse reflection element 36 and reflects light that is incident from the wavelength conversion device 4A and that has a wavelength longer than that of the blue light.

In detail, the optical separation section 33 transmits a first partial light, which is a part of the blue light incident from the diffuse transmission section 32, so as to be incident on the first optical condensing element 34, and reflects a second partial light, which is the remaining blue light, so as to be incident on the second optical condensing element 35.

In the present embodiment, in consideration of light absorption in the wavelength conversion device 4A, the optical separation section 33 increases the light amount of the first partial light to be larger than the light amount of the second partial light. However, the present disclosure is not limited to this, and the light amount of the first partial light may be the same as the light amount of the second partial light or may be smaller than the light amount of the second partial light.

The first optical condensing element 34 condenses the first partial light that passed through the optical separation section 33 at the wavelength conversion device 4A. The first optical condensing element 34 collimates the light incident from the wavelength conversion device 4A.

In the present embodiment, the first optical condensing element 34 includes two lenses 341 and 342, but the number of lenses constituting the first optical condensing element 34 is not limited to two.

The wavelength conversion device 4A diffuses and emits the light that was obtained by converting the wavelength of the incident light, in a direction opposite to the direction of the light incident on the wavelength conversion device 4A. Specifically, the wavelength conversion device 4A is excited by the blue light as the exciting light incident thereon, and diffuses and emits fluorescence having wavelengths longer than the wavelengths of the incident blue light toward the first optical condensing element 34. That is, the wavelength conversion device 4A converts light having a first waveband emitted from the light source 31 into light having a second waveband different from the first waveband. The light emitted from the wavelength conversion device 4A is, for example, fluorescence with peak wavelengths around 500 to 700 nm.

The fluorescence emitted from the wavelength conversion device 4A passes through the first optical condensing element 34 along the illumination optical axis Ax1, and then is incident on the optical separation section 33. The fluorescence incident on the optical separation section 33 is reflected in the direction along the illumination optical axis Ax2 by the optical separation section 33 and is incident on the phase difference section 37.

The configuration of the wavelength conversion device 4A will be described in detail later.

The second optical condensing element 35 condenses the second partial light reflected by the optical separation section 33 and incident on the diffuse reflection element 36. The second optical condensing element 35 collimates the blue light incident from the diffuse reflection element 36.

In the present embodiment, the second optical condensing element 35 includes two lenses 351 and 352, similarly to the first optical condensing element 34, but the number lenses constituting the second optical condensing element 35 is not limited to two.

The diffuse reflection element 36 includes a substrate 361 and a diffuse reflection layer 362 provided at a position facing the second optical condensing element 35 on the substrate 361.

The diffuse reflection layer 362 reflects and diffuses the blue light incident from the second optical condensing element 35 at the same diffusion angle as that of the fluorescence emitted from the wavelength conversion device 4A. That is, the diffuse reflection layer 362 reflects and diffuses the incident light without converting the wavelength of the incident light.

The blue light reflected by the diffuse reflection layer 362 passes through the second optical condensing element 35, then passes through the optical separation section 33, and is incident on the phase difference section 37. That is, the light incident on the phase difference section 37 from the optical separation section 33 is white light in which blue light and fluorescence are mixed.

The phase difference section 37 converts the white light incident from the optical separation section 33 into mixed s-polarized and p-polarized light. The white illumination light, which was converted as described above, is incident on the homogenization optics system 21.

### Configuration of Wavelength Conversion Device

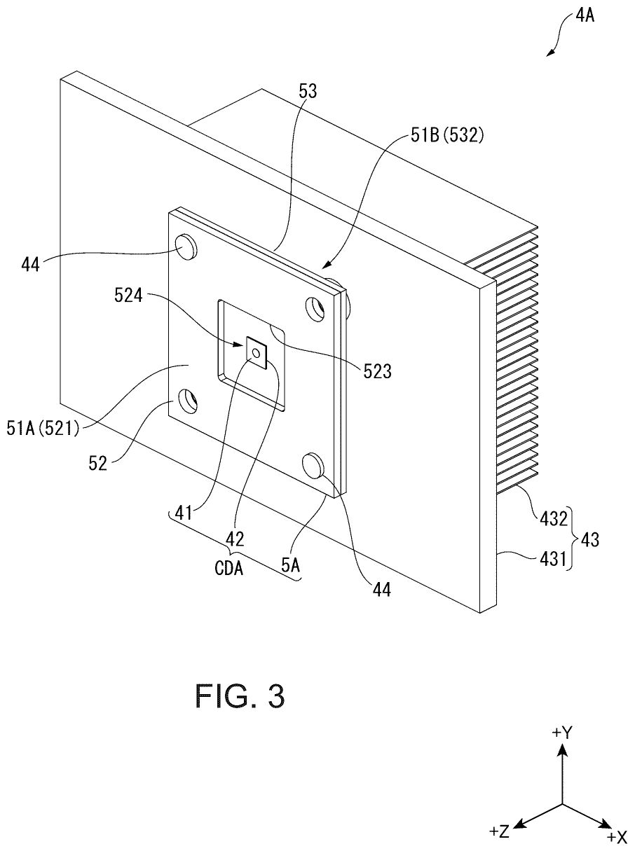

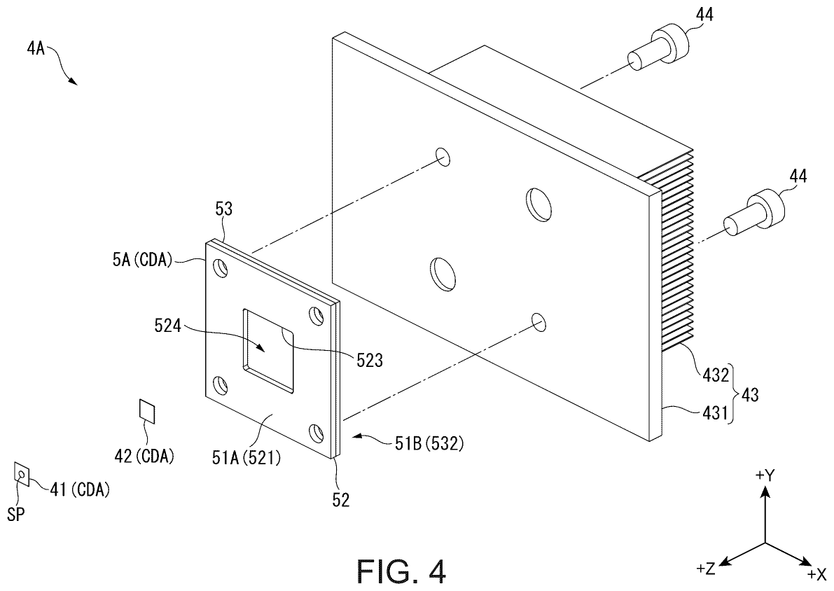

FIG. 3 is a perspective view showing the wavelength conversion device 4A as viewed from the excitation light incident side, and FIG. 4 is an exploded perspective view showing the wavelength conversion device 4A as viewed from the excitation light incident side.

As shown in FIGS. 2 to 4, the wavelength conversion device 4A includes the fluorescent substance 41, bonding material 42, a heat radiation member 43, a fixing member 44, and a vapor chamber 5A.

In the following description, three directions orthogonal to each other are referred to as a +X direction, a +Y direction, and a +Z direction. A direction opposite to the +X direction is defined as a −X direction, a direction opposite to the +Y direction is defined as a −Y direction, and a direction opposite to the +Z direction is defined as a −Z direction.

In the present embodiment, the +Z direction is a direction in which the fluorescence is emitted from the fluorescent substance 41. That is, the excitation light emitted from the first optical condensing element 34 travels in the −Z direction and is incident on the fluorescent substance 41, and the fluorescent substance 41 emits the fluorescence in the +Z direction.

The fluorescent substance 41 is provided on a first outer surface 51A of the vapor chamber 5A. More specifically, the fluorescent substance 41 is provided in a placement region 524 of a first surface 521 constituting the first outer surface 51A of a first substrate 52 constituting the vapor chamber 5A. The fluorescent substance 41 includes fluorescent substance particles. The blue light from the light source 31 is incident on the fluorescent substance 41 as excitation light in the −Z direction via the first optical condensing element 34 and the like. The fluorescent substance 41 emits fluorescence, which is unpolarized light obtained by converting the wavelength of the incident blue light, in the +Z direction. A circle on the fluorescent substance 41 shown in FIGS. 3 and 4 is a spot SP indicating a position on which the excitation light is incident.

In the present embodiment, the fluorescent substance 41 is formed in a rectangular shape when viewed from the +Z direction but may be formed in a circular shape or another polygonal shape.

The bonding material 42 is a heat conductive bonding material and bonds the first substrate 52 of the vapor chamber 5A and the fluorescent substance 41. The bonding material 42 is composed of, for example, a silver paste containing silver nanoparticles. After bonding the first substrate 52 and the fluorescent substance 41, it functions as a reflective layer that reflects the fluorescence incident from the fluorescent substance 41 back towards the fluorescent substance 41. That is, the wavelength conversion device 4A includes a reflective layer arranged between the fluorescent substance 41 and the first substrate 52. The reflective layer may not be formed of the bonding material 42 and may be formed on another surface opposed to one of the fluorescent substance 41 or the first substrate 52. The surface of the first substrate 52 facing the fluorescent substance 41 may function as a reflective layer.

The heat radiation member 43 is coupled in a heat transferable manner to a second outer surface 51B, which is on the opposite side of the vapor chamber 5A than the first outer surface 51A on which the fluorescent substance 41 is provided. The heat radiation member 43 includes a heat receiver plate 431 and a plurality of fins 432.

The heat receiver plate 431 is coupled in a heat transferable manner to the second outer surface 51B via a heat conductive grease or the like, and receives heat radiated from the second outer surface 51B.

Each of the plurality of fins 432 extends from the heat receiver plate 431, in a direction opposite from the vapor chamber 5A. Each of the plurality of fins 432 dissipates heat transferred from the heat receiver plate 431. A cooling gas is circulated through the plurality of fins 432 by a fan (not shown). By this the heat radiation member 43 and the fluorescent substance 41 are cooled.

The fixing member 44 fixes the heat radiation member 43 to the vapor chamber 5A. Specifically, the fixing member 44 passes through the heat receiver plate 431 and is inserted into the vapor chamber 5A, thereby fixing the heat radiation member 43 to the vapor chamber 5A in a heat transferable manner. In the present embodiment, the wavelength conversion device 4A has two fixing members 44, but the number of fixing members 44 can be changed as appropriate.

### Configuration of Vapor Chamber

The vapor chamber 5A supports the fluorescent substance 41 and dissipates heat that is transferred from the fluorescent substance 41 via the bonding material 42 to the heat radiation member 43, thereby cooling the fluorescent substance 41. The vapor chamber 5A constitutes a cooling device CDA together with the fluorescent substance 41 and the bonding material 42. That is, the projector 1 as the electronic device includes the cooling device CDA having the fluorescent substance 41 as the heat-generating body, the bonding material 42, and the vapor chamber 5A.

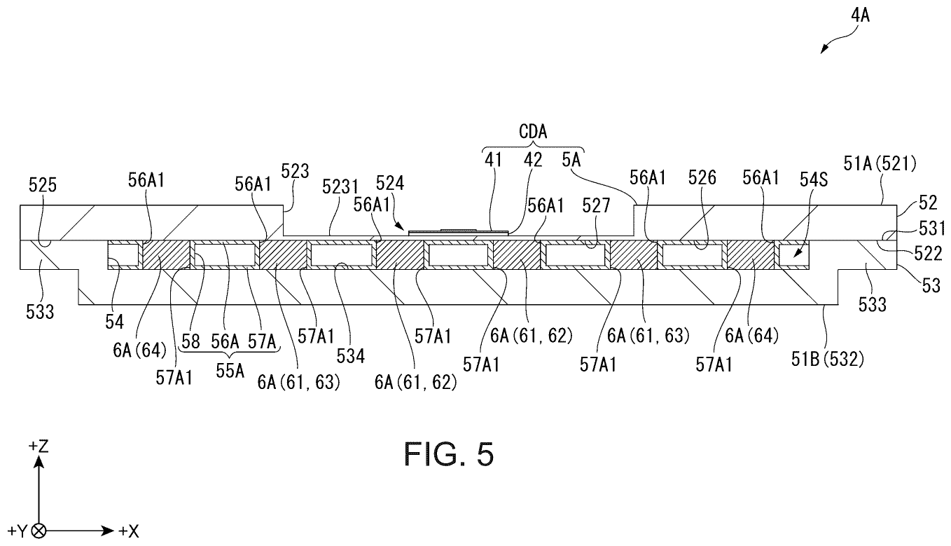

FIG. 5 is a view showing internal structure of the vapor chamber 5A. Specifically, FIG. 5 is a cross-sectional view of the vapor chamber 5A taken along the XZ plane as viewed from the −Y direction.

The vapor chamber 5A includes the first outer surface 51A, the second outer surface 51B, the first substrate 52, and a second substrate 53 as shown in FIGS. 3 to 5, and further includes an accommodation chamber 54, a capillary force structure body 55A, and a plurality of pillars 6A as shown in FIG. 5.

The first outer surface 51A is an outer surface of the vapor chamber 5A facing in the +Z direction.

The second outer surface 51B is an outer surface of the vapor chamber 5A facing in the −Z direction. As described above, the first outer surface 51A and the second outer surface 51B face away from each other on the vapor chamber 5A.

### Configuration of the First Substrate

The first substrate 52 is a plate-shaped substrate formed of a metal with good thermal conductivity, such as copper. That is, the first substrate 52 exhibits thermal conductivity. As shown in FIG. 5, the first substrate 52 is positioned in the +Z direction with respect to the second substrate 53 and is combined with the second substrate 53 to configure the accommodation chamber 54. The first substrate 52 includes a first surface 521, a second surface 522, a recessed section 523, a placement region 524, a first peripheral section 525, a first inner surface 526, and a corresponding region 527.

The first surface 521 is a surface of the first substrate 52 facing the +Z direction and is a surface of the first substrate 52 on the opposite side to the second substrate 53. The first surface 521 constitutes a first outer surface 51A.

The recessed section 523 is provided at the center of the first surface 521 when viewed from the +Z direction. The recessed section 523 is a recessed portion recessed in the −Z direction from the first surface 521, and a bottom section 5231 of the recessed section 523 is formed in a flat shape substantially orthogonal to the +Z direction. A placement region 524 is set at the center of the bottom section 5231 when viewed from the +Z direction. When viewed from the +Z direction, a thickness dimension of the outer portion of the recessed section 523 in the first substrate 52 is between 0.8 mm and 2.0 mm inclusive. In other words, the thickness dimension of the entire first substrate 52 is between 0.8 mm and 2.0 mm inclusive. On the other hand, the thickness dimension of the first substrate 52 at the bottom section 5231 of the recessed section 523 is between 0.15 mm and 0.60 mm inclusive. That is, the thickness dimension of the first substrate 52 at the bottom section 5231 of the recessed section 523 is smaller than the thickness dimension of the entire first substrate 52. The thickness dimension is a dimension in the +Z direction. In other words, the distance between the bottom section 5231 and the first inner surface 526 is smaller than the distance between the first surface 521 and the first inner surface 526.

The placement region 524 is a region in which the fluorescent substance 41 and the bonding material 42 are arranged. In detail, the placement region 524 is a region which overlaps each of the fluorescent substance 41 and the bonding material 42 when viewed from the +Z direction in the bottom section 5231. For example, when the area of the bonding material 42 is equal to or larger than the area of the fluorescent substance 41, the placement region 524 is a region overlapping the fluorescent substance 41 when viewed from the +Z direction. For example, in a case where the area of the bonding material 42 is smaller than the area of the fluorescent substance 41, the placement region 524 is a region which overlaps the bonding material 42 when viewed from the +Z direction.

The second surface 522 is a surface facing the −Z direction in the first substrate 52.

The first peripheral section 525 is a peripheral portion of the second surface 522. The first peripheral section 525 is bonded to a second peripheral section 533 (to be described later) of the second substrate 53.

The first inner surface 526 is the surface inside the first peripheral section 525 on the second surface 522, and it constitutes the inner surface on the side of the first substrate 52 in the accommodation space 54S of the accommodation chamber 54. A first capillary force structure body 56A (to be described later) of the capillary force structure body 55A is provided on the first inner surface 526.

The corresponding region 527 is a region that overlaps the bottom section 5231 of the recessed section 523 in the first inner surface 526 when viewed from the −Z direction. That is, in the present embodiment, the corresponding region 527 is a region corresponding to the bottom section 5231 in the first inner surface 526.

### Second Substrate Configuration

The second substrate 53 is a recessed shape substrate formed of the same material as that of the first substrate 52. That is, the second substrate 53 has thermal conductivity. The thickness dimension of the entire second substrate 53 is greater than the thickness dimension of the entire first substrate 52. The second substrate 53 is positioned in the −Z direction with respect to the first substrate 52 and is combined with the first substrate 52 to form the accommodation chamber 54. The second substrate 53 has a first surface 531, a second surface 532, the second peripheral section 533, and a second inner surface 534.

The first surface 531 is a surface of the second substrate 53 facing in the +Z direction.

The second peripheral section 533 is a portion protruding in the +Z direction from the peripheral portion of the first surface 531. The first peripheral section 525 and the second peripheral section 533 are bonded to each other to form the vapor chamber 5A.

The second inner surface 534 is a surface of the first surface 531 inside of the second peripheral section 533 and forms an inner surface on the second substrate 53 side in the accommodation space 54S of the accommodation chamber 54. The second inner surface 534 is provided with a second capillary force structure body 57A (to be described later) of the capillary force structure body 55A.

The second surface 532 is a surface facing the +Z direction in the second substrate 53 and constitutes the second outer surface 51B. That is, the heat receiver plate 431 of the heat radiation member 43 is coupled to the second surface 532 in a heat transferable manner.

### Configuration of Accommodation Chamber and Working Medium

The accommodation chamber 54 has the accommodation space 54S, which is formed between the first substrate 52 and the second substrate 53 by bonding the first peripheral section 525 and the second peripheral section 533. The accommodation space 54S houses the capillary force structure body 55A and the plurality of pillars 6A, and also houses a working medium that transitions into a liquid phase and a gas phase by heat. That is, the vapor chamber 5A includes the working medium accommodated in the accommodation chamber 54.

The working medium is, for example, water, and is sealed in the accommodation chamber 54 in a decompressed state. The working medium transitions from a liquid phase to a gas phase by heat, diffuses throughout the accommodation chamber 54, and then condenses and transitions back from the gas phase to the liquid phase. For example, the working medium in the liquid phase is vaporized by heat transmitted from the heat-generating body disposed in the placement region 524 and diffuses through the accommodation chamber 54 by the heat. The working medium in the gas phase diffused in the accommodation chamber 54 condenses into the working medium in the liquid phase, for example, by transferring heat to the second inner surface 534. The liquid-phase working medium is held by the capillary force structure body 55A (to be described later) and is transported by capillary force to a position in the accommodation chamber 54 where the working medium is easily vaporized. The position where the working medium is easily vaporized is, for example, the corresponding region 527 corresponding to the recessed section 523 including the placement region 524 in which the fluorescent substance 41 as the heat-generating body is arranged.

### Capillary Force Structure Body Configuration

The capillary force structure body 55A holds the working medium in a liquid phase. The capillary force structure body 55A transports the liquid-phase working medium to a position near the fluorescent substance 41, which is a heat-generating body, by capillary forces. As shown in FIG. 5, the capillary force structure body 55A includes the first capillary force structure body 56A, the second capillary force structure body 57A, and a third capillary force structure body 58, and each of the capillary force structure bodies 56A, 57A, and 58 is constituted by, for example, a wick or a mesh.

The first capillary force structure body 56A is provided on the first inner surface 526 and is bonded to the first inner surface 526. In the present embodiment, the first capillary force structure body 56A has a hole section 56A1 through which the pillar 6A (to be described later) is inserted.

The second capillary: structure body 57A is arranged on the second inner surface 534 and bonded to the second inner surface 534. In the present embodiment, the second capillary force structure body 57A has a hole section 57A1 through which the pillar 6A (to be described later) is inserted.

The third capillary force structure body 58 is provided on an outer peripheral surface of the pillar 6A (to be described later). The third capillary force structure body 58 couples the second capillary force structure body 57A with the first capillary force structure body 56A such that liquid phase working medium can move from the second capillary force structure body 57A to the first capillary force structure body 56A via the third capillary force structure body 58.

### Pillar Configuration

The plurality of pillars 6A are arranged between the first inner surface 526 and the second inner surface 534 that constitute the accommodation space 54S of the accommodation chamber 54. In the present embodiment, one end of each of the plurality of pillars 6A is inserted through a hole section 56A1 of the first capillary force structure body 56A in the +Z direction and bonded to the first inner surface 526, and the other end of each of the plurality of pillars 6A is inserted through a hole section 57A1 of the second capillary force structure body 57A in the −Z direction and bonded to the second inner surface 534. The plurality of pillars 6A couple with the first inner surface 526 and the second inner surface 534, and function to maintain the shape of the vapor chamber 5A. For example, the plurality of pillars 6A suppress expansion of the vapor chamber 5A, and also suppress inward deformation of the vapor chamber 5A when a force is applied from the outside.

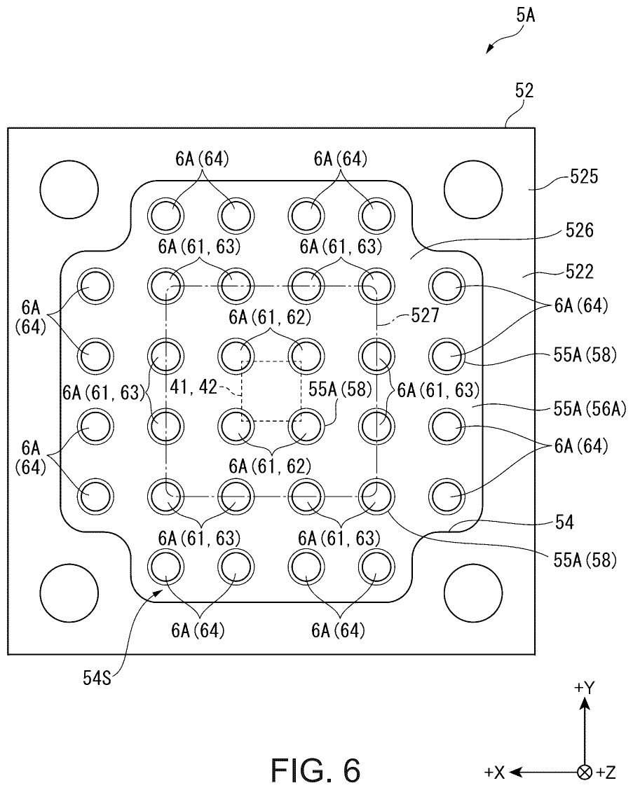

FIG. 6 is a view of the vapor chamber 5A from the −Z direction, showing the state with the second substrate 53 removed.

As shown in FIG. 6, the plurality of pillars 6A is arranged at regular intervals inside the accommodation chamber 54 when viewed from the −Z direction. As shown in FIG. 6, the plurality of pillars 6A include a plurality of inner pillars 61 and a plurality of outer pillars 64.

The plurality of inner pillars 61 are arranged in the corresponding region 527 within the accommodation chamber 54. In detail, each of the plurality of inner pillars 61 is arranged so that at least a part thereof is positioned in the corresponding region 527 in the accommodation chamber 54. The plurality of inner pillars 61 include a plurality of interior pillars 62 and a plurality of peripheral pillars 63.

The plurality of interior pillars 62 are inner pillars at least a part of which is arranged in a region corresponding to the placement region 524 in the corresponding region 527 when viewed from the second substrate 53 side with respect to the first substrate 52. In the present embodiment, among the plurality of inner pillars 61, each of the four inner pillars 61 overlapping with the placement region 524 is an interior pillar 62, and each interior pillar 62 is arranged at regular intervals along the peripheral edge of the placement region 524. In the present embodiment, the peripheral edge of the region corresponding to the placement region 524 corresponds to a peripheral edge formed by at least one of the peripheral edge of the fluorescent substance 41 and the peripheral edges of the bonding material 42 when viewed from the +Z direction, as indicated by a dotted line in FIG. 6.

The plurality of peripheral pillars 63 are the inner pillars 61 arranged along the peripheral edge of the corresponding region 527 indicated by the one dot chain line in FIG. 6 among the plurality of inner pillars 61 and are an example of the peripheral pillars of the present disclosure. The plurality of peripheral pillars 63 is arranged at regular intervals along the peripheral edge of the corresponding region 527, and each peripheral pillar 63 is arranged spanning inside and outside the peripheral edge of the corresponding region 527. Since at least the part of peripheral pillars 63 are arranged inside the corresponding region 527, the peripheral pillars 63 can be referred to as inner peripheral pillars. In the present embodiment, the peripheral edge of the corresponding region 527 corresponds to the peripheral edge of the bottom section 5231 of the recessed section 523 when viewed from the +Z direction, as shown by the one dot chain line in FIG. 6.

The plurality of outer pillars 64 are arranged outside the corresponding region 527 in the accommodation chamber 54. More specifically, each of the plurality of outer pillars 64 is arranged such that all the outer pillars 64 are positioned outside the corresponding region 527. The plurality of outer pillars 64 is arranged at substantially regular intervals along the +X direction and the +Y direction in the accommodation chamber 54.

In the present embodiment, the plurality of outer pillars 64 is arranged at regular intervals outside the corresponding region 527 along the peripheral edge of the corresponding region 527. Therefore, the plurality of outer pillars 64 correspond to a plurality of peripheral pillars arranged along the peripheral edge of the outside the corresponding region 527. Since the plurality of outer pillars 64 are arranged outside the corresponding region 527, the plurality of outer pillars 64 can also be referred to as a plurality of outer peripheral pillars arranged along the peripheral edge of the corresponding region 527.

In the present embodiment, each of an inner pillar 61 and an outer pillar 64 is formed in a cylindrical shape when viewed from the +Z direction. That is, the interior pillars 62, the peripheral pillars 63, and the outer pillars 64 are each formed in a cylindrical shape when viewed from the +Z direction. However, the present disclosure is not limited to this, and at least one of the pillars 62 to 64 may be formed in a prismatic shape. In addition, at least one of the pillars 62 to 64 may be formed in a shape in which the cross-sectional area along the XY plane decreases toward the center in the +Z direction and increases toward the +Z direction and the −Z direction from the center in the +Z direction.

### Effects of First Embodiment

The projector 1 according to the present embodiment described above has the following effects.

The projector 1 as the electronic device includes the cooling device CDA.

The cooling device CDA includes the vapor chamber 5A and the fluorescent substance 41 bonded to a placement region 524 of the vapor chamber 5A. The fluorescent substance 41 corresponds to a heat-generating body.

The vapor chamber 5A includes the first substrate 52, the second substrate 53, the accommodation chamber 54, the working medium, and the plurality of pillars 6A.

The substrate 52 is a thermally conductive substrate that has the placement region 524 arranged in which the fluorescent substance 41 as a heat-generating body is arranged.

The second substrate 53 is a thermally conductive substrate facing the first substrate 52.

The accommodation chamber 54 has an accommodation space 54S formed by bonding a first peripheral section 525, which is a peripheral edge of the first substrate 52, and a second peripheral section 533, which is a peripheral edge of the second substrate 53.

The working medium is accommodated in the accommodation chamber 54 and is transitioning between a gas phase and a liquid phase by heat.

The plurality of pillars 6A are arranged between the first inner surface 526 of the first substrate 52 and the second inner surface 534 of the second substrate 53 in the accommodation chamber 54.

The first substrate 52 has a first surface 531 on the side opposite to the second substrate 53 and a recessed section 523 recessed from the first surface 531. The thickness dimension of the first substrate 52 at the bottom section 5231 of the recessed section 523 is smaller than the thickness dimension of the entire first substrate 52. The placement region 524 is provided on the bottom section 5231 of the recessed section 523.

According to the configuration of such the vapor chamber 5A, the thickness dimension of the placement region 524, where the fluorescent substance 41, which is a heat-generating body, is arranged on the first substrate 52, is smaller than the thickness dimension of the peripheral portion of the recessed section 523 on the first substrate 52. So, this allows the distance between the fluorescent substance 41 and the accommodation chamber 54 to be shortened, making it easier to transfer the heat transmitted from the fluorescent substance 41 to the first substrate 52 to the liquid phase working medium contained in the accommodation chamber 54. By this, the liquid phase working medium can be easily transitioned into the gas phase working medium by the heat of the fluorescent substance 41, and the heat of the fluorescent substance 41 can be easily consumed. Therefore, the cooling performance for the fluorescent substance 41 can be enhanced. On the other hand, since the thickness dimension of the peripheral portion of the recessed section 523 is larger than the thickness dimension of the bottom section of the recessed section 523, for example, when the fluorescent substance 41 is bonded to the placement region 524, it is possible to suppress the first substrate 52 from being expanded and deformed. Therefore, the pressure resistance of the vapor chamber 5A can be maintained.

Therefore, it is possible to suppress the expansion of the vapor chamber 5A while maintaining the diffusivity of the working medium in the vapor chamber 5A. By this, the cooling device CDA including the vapor chamber 5A can be a cooling device capable of suppressing expansion of the vapor chamber 5A while cooling the fluorescent substance 41. Further, since the projector 1, which is the electronic device, has the cooling device CDA, it can be a projector that can operate stably.

The projector 1 further includes the light source 31, the wavelength conversion device 4A on which light from the light source 31 is incident as exciting light, the image forming device 24, and the projection optical device 26.

The image forming device 24 forms image light from the light including the fluorescence emitted from the fluorescent substance of the wavelength conversion device 4A. The projection optical device 26 projects the image light.

The wavelength conversion device 4A includes the cooling device CDA. A heat-generating body arranged in the placement region 524 of the first substrate 52 constituting the vapor chamber 5A of a cooling device CDA is the fluorescent substance 41 for emitting fluorescence by converting wavelengths of incident light. The fluorescent substance 41 is bonded to the placement region 524 via the thermally conductive bonding material 42.

According to such a configuration, since it is possible to stably cool the fluorescent substance 41, it is possible to configure the wavelength conversion device 4A capable of stably emitting the fluorescence, and thus it is possible to configure the projector 1 capable of stably operating.

In the vapor chamber 5A, the thickness dimension of the entire first substrate 52 is between 0.8 mm and 2.0 mm inclusive, and the thickness dimension at the bottom section 5231 of the recessed section 523 is between 0.15 mm and 0.60 mm inclusive.

According to such a configuration, since the thickness dimension of the first substrate 52 is within the above-described thickness dimension range, it is possible to secure the pressure resistance of the vapor chamber 5A when the fluorescent substance 41 is bonded to the placement region 524. In addition, since the thickness dimension of the bottom section 5231 of the recessed section 523 is a thickness within the above-described thickness dimension range, it is possible to improve the heat transfer efficiency from the fluorescent substance 41 to the working medium.

In the vapor chamber 5A, the first substrate 52 has the corresponding region 527 corresponding to the bottom section 5231 of the recessed section 523 on the first inner surface 526. The corresponding region 527 is a region of the first inner surface 526 that overlaps the bottom section 5231 when viewed from the −Z direction.

The plurality of pillars 6A include the plurality of peripheral pillars 63 arranged on the peripheral edge of the corresponding region 527. In addition, the plurality of pillars 6A includes the plurality of outer pillars 64 disposed on the peripheral edge of the corresponding region 527. The outer pillar 64 is one of the peripheral pillar of the present disclosure.

According to such a configuration, it is possible to ensure the pressure resistance of the vapor chamber 5A by the plurality of peripheral pillars 63 provided corresponding to the peripheral edge of the corresponding region 527 which may have a high temperature when the fluorescent substance 41 is bonded to the placement region 524.

In the vapor chamber 5A, the plurality of outer pillars 64, which are one of the peripheral pillars, are arranged the outer side of the peripheral edge of the corresponding region 527 along the peripheral edge of the corresponding region 527.

According to such a configuration, the plurality of outer pillars 64 are arranged the outer side of the peripheral edge of the corresponding region 527 when viewed from the second substrate 53 side with respect to the first substrate 52. For this reason, it is possible to suppress deformation and expansion of the vapor chamber 5A at the peripheral edge of the corresponding region 527, that is, the peripheral edge of the recessed section 523, and it is possible to further increase the pressure resistance of the vapor chamber 5A.

In the vapor chamber 5A, the plurality of peripheral pillars 63 are arranged spanning inside and outside the peripheral edge of the corresponding region 527.

According to such a configuration, it is possible to suppress deformation and expansion of the vapor chamber 5A at the peripheral edge of the corresponding region 527, that is, at the peripheral edge of the recessed section 523, and to further increase the pressure resistance of the vapor chamber 5A.

In the vapor chamber 5A, the plurality of pillars 6A is arranged at regular intervals.

According to such a configuration, since the plurality of pillars 6A is arranged at regular intervals, the pressure resistance can be maintained in the entire vapor chamber 5A.

The vapor chamber 5A is provided on the first inner surface 526 in the accommodation chamber 54 and includes the first capillary force structure body 56A that holds the liquid phase working medium.

According to such a configuration, it is possible to easily supply the working medium in a liquid phase to the corresponding region 527 to which heat from the fluorescent substance 41 which is a heat-generating body is transmitted. Therefore, the heat transfer efficiency from the fluorescent substance 41 to the working medium can be increased, and the cooling efficiency of the fluorescent substance 41 can be increased.

The vapor chamber 5A includes the first capillary force structure body 56A which is provided on the first inner surface 526 in the accommodation chamber 54 and holds the liquid phase working medium, and the inner pillar 61 is bonded to the first inner surface 526 while avoiding the first capillary force structure body 56A.

According to such a configuration, the inner pillar 61 can be directly bonded to the first inner surface 526. Therefore, the bonding strength between the inner pillar 61 and the first inner surface 526 can be increased, and the pressure resistance of the vapor chamber 5A can be further increased.

In the present embodiment, each of the plurality of pillars 6A, including the inner pillar 61 and outer pillar 64, is bonded to the first inner surface 526 while avoiding the first capillary force structure body 56A.

### Modifications of First Embodiment

In the vapor chamber 5A, one end of each pillar 6A is bonded to the first inner surface 526 via the hole section 56A1 of the first capillary force structure body 56A, and the other end of each pillar 6A is bonded to the second inner surface 534 via the hole section 57A1 of the second capillary force structure body 57A. However, the present disclosure is not limited to this, and the bonded state of the plurality of pillars 6A and the first substrate 52 and the second substrate 53 is not limited to the above.

### First Modification of First Embodiment

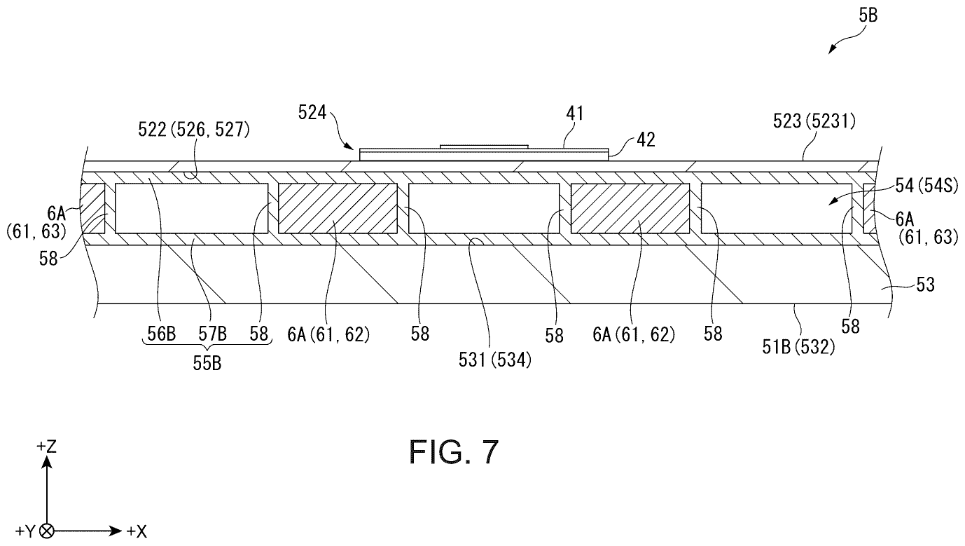

FIG. 7 is a view showing a part of a cross section along the XZ plane of a vapor chamber 5B which is a first modification of the vapor chamber 5A.

The vapor chamber 5B shown in FIG. 7 has the same configuration and function as those of the vapor chamber 5A described above except that a capillary force structure body 55B is provided instead of the capillary force structure body 55A. The capillary force structure body 55B includes a first capillary force structure body 56B and a second capillary force structure body 57B instead of the first capillary force structure body 56A and the second capillary force structure body 57A, and further includes the third capillary force structure body 58, and functions in the same manner as the capillary force structure body 55A.

The first capillary force structure body 56B is bonded to the first inner surface 526, and the second capillary force structure body 57B is bonded to the second inner surface 534. Here, the first capillary force structure body 56B does not include the hole section 56A1, and the second capillary force structure body 57B does not include with the hole section 57A1. For this reason, an end section in the +Z direction, which is one end, of the pillar 6A is bonded to the surface of the first capillary force structure body 56B that faces the −Z direction, and an end section in the −Z direction, which is the other end, of the pillar 6A is bonded to the surface of the second capillary force structure body 57B that faces the +Z direction. In the example of FIG. 7, one end of the inner pillar 61 is bonded to the first inner surface 526 via the first capillary force structure body 56B, and the other end of the inner pillar 61 is bonded to the second inner surface 534 via the second capillary force structure body 57B.

The vapor chamber 5B described above has following additional effects in addition to the same effects similar to those of the vapor chamber 5A.

The vapor chamber 5B is provided on the first inner surface 526 in the accommodation chamber 54 and includes the first capillary force structure body 56B that holds the liquid phase working medium.

The inner pillar 61 is joined to the first inner surface 526 via the first capillary force structure body 56B.

According to such a configuration, it is possible to suppress a decrease in the areas of the first capillary force structure body 56B due to the inner pillar 61, and therefore, it is possible to suppress a decrease of the ability of the first capillary force structure body 56B to retain, and the ability to transport, the working medium in the liquid phase. Therefore, the liquid-phase working medium can be efficiently transported to the corresponding region 527. This increases the efficiency of heat transfer from the fluorescent substance 41 that is the heat-generating body to the liquid-phase working medium.

### Second Modification of First Embodiment

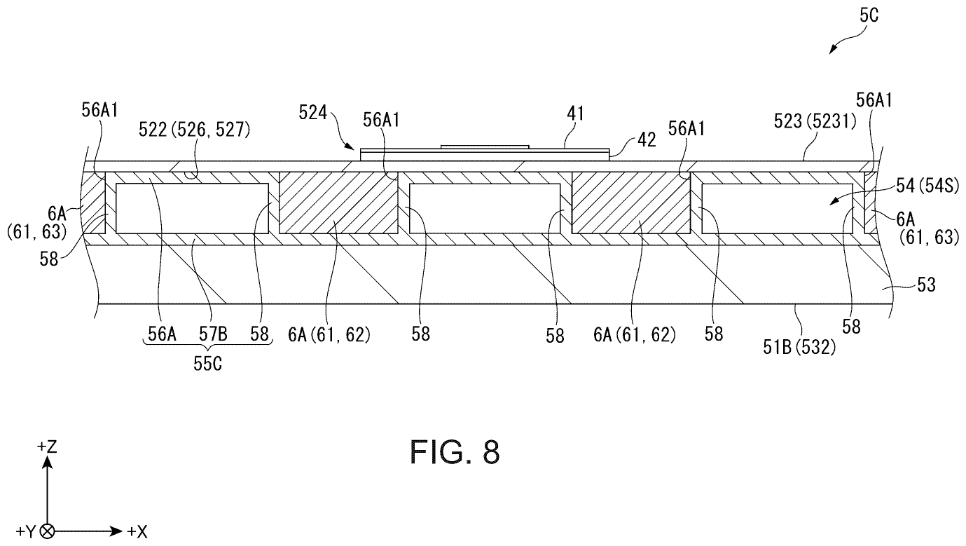

FIG. 8 is a view showing a part of a cross section along the XZ plane of a vapor chamber 5C, which is a second modification of the vapor chamber 5A.

One of the first capillary force structure bodies 56A and 56B may be combined with one of the second capillary force structure bodies 57A and 57B.

The vapor chamber 5C shown in FIG. 8 has the same configuration and function as the vapor chamber 5A described above, except that a capillary force structure body 55C is provided instead of the capillary force structure body 55A. The capillary force structure body 55C comprises the first capillary force structure body 56A, the second capillary force structure body 57B, and the third capillary force structure body 58, and functions in the same way as the capillary force structure body 55A.

In the vapor chamber 5C, one end of each pillar 6A is inserted through the hole section 56A1 of the first capillary force structure body 56A and bonded to the first inner surface 526, and the other end of the pillar 6A is bonded to a surface of the second capillary force structure body 57B facing the +Z direction. For example, one end of each pillar 6A is bonded to the first inner surface 526 while avoiding the first capillary force structure body 56A, and the other end of each pillar 6A is bonded to the second inner surface 534 via the second capillary force structure body 57B. In the example of FIG. 8, one end of the inner pillar 61 is bonded to the first inner surface 526 while avoiding the first capillary force structure body 56A, and the other end of the inner pillar 61 is bonded to the second inner surface 534 via the second capillary force structure body 57B.

The vapor chamber 5C described above has following additional effects in addition to the same effects similar to those of the vapor chamber 5A.

The vapor chamber 5C includes the first capillary force structure body 56A provided on the first inner surface 526 in the accommodation chamber 54 and configured to hold the liquid phase working medium, and the second capillary force structure body 57B provided on the second inner surface 534 in the accommodation chamber 54 and configured to hold the liquid phase working medium.

One end of the inner pillar 61 is bonded to the first inner surface 526 while avoiding the first capillary force structure body 56A, and the other end of the inner pillar 61 is bonded to the second inner surface 534 via the second capillary force structure body 57B. The first inner surface 526 corresponds to the inner surface of the first substrate 52, and the second inner surface 534 corresponds to the inner surface of the second substrate 53.

According to such a configuration, one end of the inner pillar 61 can be directly bonded to the first inner surface 526. Therefore, it is possible to increase the bonding strength between the inner pillar 61 and the first inner surface 526.

Since the inner pillar 61 can suppress a decrease in the area size of the second capillary force structure body 57B, it is possible to suppress a decrease in the ability of the second capillary force structure body 57B to retain and the ability of transport the liquid-phase working medium.

Therefore, the pressure-resistant strength of the vapor chamber 5C can be further increased, and the liquid-phase working medium can be efficiently transported toward the corresponding region 527. Therefore, heat can be efficiently transferred from the fluorescent substance 41, which is a heat-generating body, to the liquid-phase working medium.

### Third Modification of First Embodiment

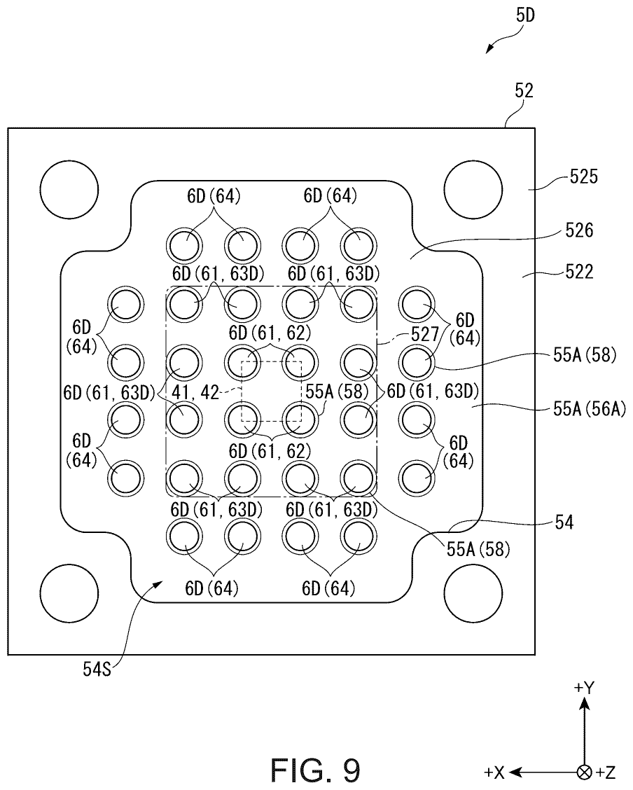

FIG. 9 is a view showing an internal structure of a vapor chamber 5D which is a third modification of the vapor chamber 5A. In detail, FIG. 9 is a view of the vapor chamber 5D with the second substrate 53 removed, as viewed from the −Z direction.

In the first embodiment, the plurality of peripheral pillars 63 are arranged on the peripheral edge of the corresponding region 527. However, the present disclosure is not limited thereto, and a plurality of peripheral pillars may be arranged along the peripheral edge inside the peripheral edge of the corresponding region 527.

For example, the vapor chamber 5D illustrated in FIG. 9 has the same configuration and function as the vapor chamber 5A described above except that the vapor chamber 5D includes a plurality of pillars 6D instead of the plurality of pillars 6A.

The plurality of pillars 6D have the same configuration and function as the plurality of pillars 6A except that the plurality of pillars 6D have a plurality of periphery pillars 63D instead of the plurality of peripheral pillars 63. That is, the plurality of inner pillars 61 in the vapor chamber 5D include the plurality of periphery pillars 63D instead of the plurality of peripheral pillars 63.

The plurality of periphery pillars 63D are arranged inside the peripheral edge of the corresponding region 527 along the peripheral edge of the corresponding region 527. Further, the plurality of periphery pillars 63D is arranged at regular intervals along the peripheral edge of the corresponding region 527, and the entire periphery pillars 63D are arranged inside the peripheral edge of the corresponding region 527 when viewed from the −Z direction.

The vapor chamber 5D described above has following additional effects in addition to the same effects similar to those of vapor chamber 5A.

That is, the plurality of periphery pillars 63D are arranged inside the peripheral edge of the corresponding region 527 along the peripheral edge of the corresponding region 527.

According to such a configuration, it is possible to suppress deformation and expansion of the vapor chamber 5D at the peripheral edge of the corresponding region 527, that is, the peripheral edge of the recessed section 523, and it is possible to further increase the pressure resistance of the vapor chamber.

### Second Embodiment

Next, a second embodiment of the present disclosure will be described.

The projector according to the present embodiment has the same configuration as that of the projector 1 according to the first embodiment, but the cross-sectional area of the pillar arranged in the accommodation chamber of the vapor chamber is different. In the following description, the same or substantially the same parts as those described above are denoted by the same reference numerals, and the description thereof will be omitted.

### Schematic Configuration of Projector and Wavelength Conversion Device

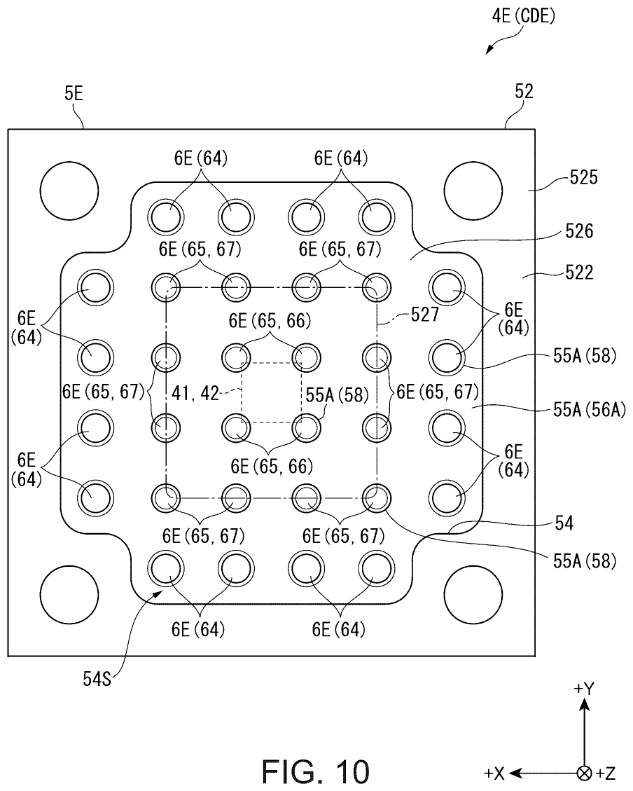

FIG. 10 is a view showing an internal structure of a vapor chamber 5E of a wavelength conversion device 4E included in the projector according to the present embodiment. In detail, FIG. 10 is a view of the vapor chamber 5E with the second substrate 53 removed, as viewed from the −Z direction.

The projector according to the present embodiment has the same configuration and function as those of the projector 1 according to the first embodiment except that the wavelength conversion device 4E shown in FIG. 10 is provided instead of the wavelength conversion device 4A.

The wavelength h conversion device 4E has the same configuration and function as the wavelength conversion device 4A according to the first embodiment, except that the wavelength conversion device 4E includes the vapor chamber 5E instead of the vapor chamber 5A. That is, the wavelength conversion device 4E according to the present embodiment includes the heat radiation member 43 in addition to the cooling device CDE that is instead of the cooling device CDA.

The cooling device CDE has the same configuration and function as those of the cooling device CDA according to the first embodiment except that the vapor chamber 5E is provided instead of the vapor chamber 5A. That is, the cooling device CDE according to the present embodiment includes the fluorescent substance 41, the bonding material 42, and the vapor chamber 5E, and functions similarly to the cooling device CDA.

### Configuration of Vapor Chamber

The vapor chamber 5E has the same configuration and function as the vapor chamber 5A, except that the vapor chamber 5E includes a plurality of pillars 6E instead of the plurality of pillars 6A. That is, the vapor chamber 5E includes the first outer surface 51A, the second outer surface 51B, the first substrate 52, the second substrate 53, the accommodation chamber 54, the capillary force structure body 55A, and the plurality of pillars 6E. The vapor chamber 5E may include the capillary force structure body 55B or the capillary force structure body 55C instead of the capillary force structure body 55A.

### Configuration of Plural Pillars

The plurality of pillars 6E include plurality of inner pillars 65 instead of the plurality of inner pillars 61, as well as the plurality of outer pillars 64, and have the same functions as the plurality of pillars 6A according to the first embodiment.

Similarly to the plurality of inner pillars 61, the plurality of inner pillars 65 are provided in the corresponding region 527 of the first substrate 52. In detail, each of the plurality of inner pillars 65 is arranged so that at least a part thereof is positioned in the corresponding region 527 in the accommodation chamber 54. An end section of each of the plurality of inner pillars 65 in the +Z direction is directly bonded to the corresponding region 527 of the first inner surface 526 while avoiding the first capillary force structure body 56A or is bonded to the corresponding region 527 via the first capillary force structure body 56B. Although not shown, an end section of each of the plurality of inner pillars 65 in the −Z direction is directly bonded to the second inner surface 534 while avoiding the second capillary force structure body 57A, or is bonded to the second inner surface 534 via the second capillary force structure body 57B.

The placement position of an inner pillar 65 in the corresponding region 527 is the same as the placement position of the inner pillar 61 in the corresponding region 527 shown in the first embodiment. That is, the plurality of inner pillars 65 include the interior pillar 66, which are positioned similarly to the interior pillar 62, and the peripheral pillar 67, which are positioned similarly to the peripheral pillar 63.

A cross-sectional area of the inner pillar 65 along the first inner surface 526 at a portion of the first substrate 52 side is smaller than a cross-sectional area of the outer pillar 64 along the first inner surface 526 at a portion of the first substrate 52 side. That is, the cross-sectional area of the interior pillar 66 along the first inner surface 526 at the portion of the first substrate 52 side is smaller than the cross-sectional area of the outer pillar 64 along the first inner surface 526 at the portion of the first substrate 52 side. The cross-sectional area of the peripheral pillar 67 along the first inner surface 526 at the portion of the first substrate 52 side is smaller than the cross-sectional area of the outer pillar 64 along the first inner surface 526 at the portion of the first substrate 52 side.

In other words, the cross-sectional area of the inner pillar 65 orthogonal to the central axis of each inner pillar 65 is smaller than the cross-sectional area of the outer pillar 64 orthogonal to the central axis of each outer pillar 64.

Although not shown, the cross-sectional area of the inner pillar 65 along the second inner surface 534 at the end section of the second substrate 53 side is smaller than the cross-sectional area of the outer pillar 64 along the second inner surface 534 at the end section of the second substrate 53 side.

As described above, the arrangement of the inner pillar 65 in the corresponding region 527 is the same as the arrangement of the inner pillar 61 in the corresponding region 527 of the vapor chamber 5A. The arrangement of the outer pillars 64 in the accommodation chamber 54 is the same as the arrangement of the outer pillars 64 in the accommodation chamber 54 of the vapor chamber 5A.

On the other hand, since the cross-sectional area of the inner pillar 65 is smaller than the cross-sectional area of the outer pillar 64, the area occupied by the inner pillar 65 in the corresponding region 527 where the working medium transitions from the liquid phase to the gas phase can be reduced. For this reason, the working medium can be easily transitioned from the liquid phase to the gas phase in the corresponding region 527, and the working medium transitioned from the liquid phase to the gas phase in the corresponding region 527 can be easily diffused to the outside of the corresponding region 527 and further to the entire accommodation chamber 54.

### Effects of Second Embodiment

The projector in the present embodiment has the following additional effects, similar to those of the projector 1 in the first embodiment.

In the vapor chamber 5E, the plurality of pillars 6E include the inner pillar 65 arranged in the corresponding region 527 and the outer pillar 64 arranged outside the corresponding region 527.

A cross-sectional area along the first inner surface 526 in a portion of the inner pillar 65 on the first substrate 52 side is smaller than a cross-sectional area along the first inner surface 526 in a portion of each outer pillars 64 on the first substrate 52 side.

According to such a configuration, it is possible to suppress the area of the portion where the working medium in the liquid phase is transitioned to the working medium in the gas phase by the heat transmitted from the fluorescent substance 41, which is the heat-generating body, in the corresponding region 527 from being reduced by the inner pillar 65. By this, it is possible to suppress the heat transfer from the first inner surface 526 to the working medium in the liquid phase from being hindered. Therefore, it is possible to suppress a decrease in the efficiency of heat transfer from the fluorescent substance 41 to the liquid-phase working medium.

### Third Embodiment

Next, a third embodiment of the present disclosure will be described.

The projector according to the present embodiment has a configuration similar to that of the projector according to the first embodiment. However, similarly the vapor chamber 5E according to the second embodiment, the cross-sectional area of the inner pillar is smaller than the cross-sectional area of the outer pillar, and the number of pillars per unit area inside the accommodation chamber of vapor chamber differs. In other words, the number of inner pillars per unit area is different between the projector according to the present embodiment and the projector according to the second embodiment. In the following description, the same or substantially the same parts as those described above are denoted by the same reference numerals, and the description thereof will be omitted.

### Schematic Configuration of Projector and Wavelength Conversion Device

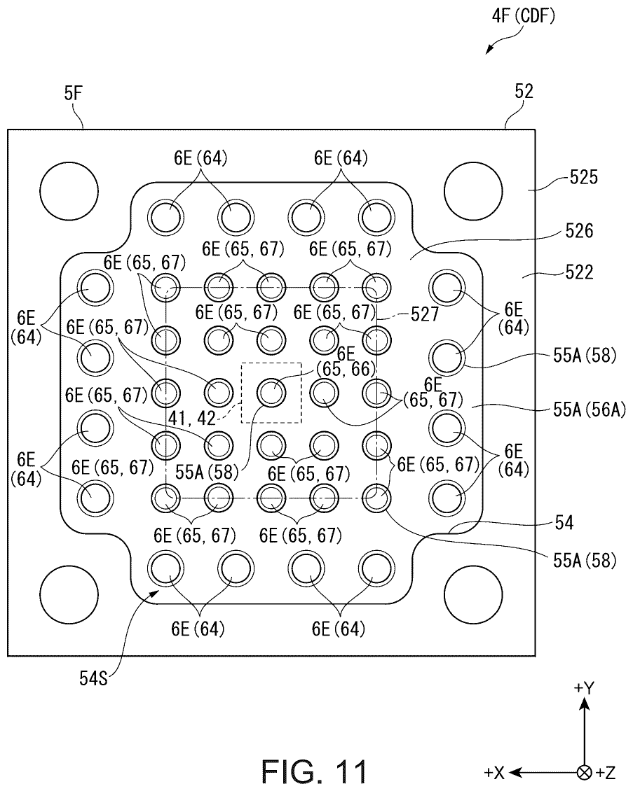

FIG. 11 is a view showing an internal structure of a vapor chamber 5F of a wavelength conversion device 4F included in the projector according to the present embodiment. In detail, FIG. 11 is a view of the vapor chamber 5F with the second substrate 53 removed, as viewed from the −Z direction.

The projector according to present embodiment has the same configuration and function as those of the projectors according to the first and second embodiments except that the projector according to this embodiment includes a wavelength conversion device 4F shown in FIG. 11 instead of the wavelength conversion devices 4A and 4E.

The wavelength conversion device 4F includes a cooling device CDF and the heat radiation member 43. The cooling device CDF includes the fluorescent substance 41, the bonding material 42, and the vapor chamber 5F.

### Configuration of Vapor Chamber

Similar to the vapor chamber 5E according to the second embodiment, the vapor chamber 5F includes the first outer surface 51A, the second outer surface 51B, the first substrate 52, the second substrate 53, the accommodation chamber 54, the capillary force structure body 55A, and the plurality of pillars 6E. The vapor chamber 5F may include the capillary force structure body 55B or the capillary force structure body 55C instead of the capillary force structure body 55A.

Here, in the vapor chamber 5F, the arrangement of the plurality of pillars 6E is different from that of the vapor chamber 5E according to the second embodiment. To be specific, in the vapor chamber 5F, the plurality of pillars 6E are arranged such that the number per unit area of the inner pillars 65 arranged in the corresponding region 527 is larger than the number per unit area of the pillars 6E arranged in the entire accommodation chamber 54.

The plurality of inner pillars 65 is arranged at regular intervals in the +X direction and the +Y direction in the corresponding region 527. On the other hand, the plurality of outer pillars 64 is arranged at regular intervals in the +X direction or the +Y direction outside the corresponding region 527.

In the present embodiment, one interior pillar 66 is provided among the plurality of inner pillars 65, the interior pillar 66 being entirely located in the region of the first inner surface 526 corresponding to the placement region 524 in which the fluorescent substance 41 and the bonding material 42 are arranged. However, the present disclosure is not limited to this, and they may be arranged at regular intervals in the region of the first inner surface 526 corresponding to the placement region 524, similarly to the vapor chambers 5A, 5B, 5C, 5D, and 5E.

The vapor chamber 5F includes a plurality of pillars 6E. However, the present disclosure is not limited thereto, and the plurality of pillars of the vapor chamber 5F may be the plurality of pillars 6A including the inner pillar 61 and the outer pillar 64. That is, in the vapor chamber 5F, it is sufficient if the number per unit area of inner pillars 65 arranged in the corresponding region 527 may be larger than the number per unit area of pillars 6E arranged in the entire accommodation chamber 54, and the cross-sectional area of the inner pillar along the first inner surface 526 may be the same as or different from the cross-sectional area of the outer pillar along the first inner surface 526.

The projector in the present embodiment has the following additional effects, similar to those of the projector 1 in the first embodiment.

In the vapor chamber 5F, the number of inner pillars 65 per unit area in the corresponding region 527 is greater than the number of pillars 6E per unit area in the entire accommodation chamber 54.

According to such a configuration, it is possible to increase pressure resistance against expansion of the vapor chamber 5F in the corresponding region 527. By this, even when a thermal load is applied to the recessed section 523 from the outside, it is possible to suppress expansion of the vapor chamber 5F.

On the other hand, the number of the outer pillar 64 per unit area arranged outside the corresponding region 527 is less than the number of inner pillars 65 per unit area arranged in the corresponding region 527. Therefore, it is easier to diffuse the working medium, which has transitioned from liquid phase to gas phase due to the heat transferred from the fluorescent substance 41, which is a heat-generating body, outside the corresponding region 527 located on the first inner surface 526.

Therefore, it is possible to suppress the expansion and deformation of the vapor chamber 5F while maintaining the diffusivity of the working medium in the vapor chamber 5F.

### Modification of the Embodiment

The present disclosure is not limited to the above-described embodiments, and modifications, improvements, and the like within a range in which the object of the present disclosure can be achieved are included in the present disclosure.

In each of the embodiments described above, the inner pillars 61 and 65 are arranged at regular intervals in the corresponding region 527, and the outer pillars 64 are arranged, in the accommodation chamber 54, at regular intervals outside the corresponding region 527. However, the present disclosure is not limited thereto, and the plurality of pillars 6A, 6D, and 6E arranged in the accommodation chamber 54 may be randomly arranged.

The plurality of pillars 6A, 6D, and 6E include the plurality of inner pillars 61 and 65 and the plurality of outer pillars 64. However, the present disclosure is not limited thereto, and for example, the plurality of pillars constituting the vapor chamber may be only the inner pillars or only the outer pillars. Further, when the plurality of pillars constituting the vapor chamber include the inner pillars, the inner pillars may include only one of the interior pillars or the peripheral pillars.

In each of the above-described embodiments, the placement region 524 where the fluorescent substance 41 as the heat-generating body is placed is a partial region of the bottom section 5231 of the recessed section 523 provided on the first surface 521 of the first substrate 52 in each of the vapor chambers 5A, 5B, 5C, 5D, 5E, and 5F. However, the present disclosure is not limited thereto, and the placement region 524 may be the entire bottom section 5231.

In each of the embodiments described above, the thickness dimension of the first substrate 52 at the bottom section 5231 of the recessed section 523 is between 0.15 mm and 0.60 mm inclusive, and the thickness dimension of the first substrate 52 outside the recessed section 523 is between 0.8 mm and 2.0 mm inclusive. However, the present disclosure is not limited thereto, the thickness dimension of the first substrate 52 at the bottom section 5231 of the recessed section 523 is not limited to the above, and the thickness dimension of the first substrate 52 outside the recessed section 523 is not limited to the above.

In each of the embodiments described above, one of the first capillary force structure bodies 56A and 56B is provided on the first inner surface 526, one of the second capillary force structure bodies 57A and 57B is provided on the second inner surface 534, and the third capillary force structure body 58 are provided on the outer peripheral surfaces of the pillars 6A, 6D, and 6E. However, the present disclosure is not limited to this, and at least one of the first capillary force structure bodies 56A and 56B, the second capillary force structure bodies 57A and 57B, and the third capillary force structure body 58 may be omitted.

The first capillary force structure bodies 56A and 56B may not be provided on the entire first inner surface 526 and may be provided on a part of the first inner surface 526. Similarly, the second capillary force structure body 57A, 57B may not be provided on the entire second inner surface 534 but may be provided on a part of the second inner surface 534.

Further, the third capillary force structure body 58 may not be provided on all of the plurality of pillars 6A, 6D, and 6E, and may be provided only on the inner pillars 61 and 65, for example.

In each of the above embodiments, the peripheral edge of the corresponding region 527 is the peripheral edge of the bottom section 5231 of the recessed section 523. However, this is not limited thereto. When a recessed section is provided to form a slope from the first surface 521 of the first substrate 52 toward the bottom section, or when a recessed section is provided to form one or more steps from the first surface 521 of the first substrate 52 toward the bottom section, the range from the peripheral edge of the recessed section from the first surface 521 of the first substrate 52 toward the −Z direction to the peripheral edge of the bottom section may be considered as the peripheral edge of the corresponding region 527. For example, the peripheral edge of the corresponding region 527 in the first inner surface 526 may be a portion corresponding to the peripheral edge of the recessed section when the recessed section in which the placement region 524 is positioned is viewed from the +Z direction, or may be a portion corresponding to a part of the range from the peripheral edge of the recessed section to the peripheral edge of the bottom section of the recessed section.

In each of the embodiments described above, the projector includes the three optical modulation elements 243R, 243G, and 243B. However, the present disclosure is not limited to this, and the present disclosure can also be applied to a projector including two or fewer, or four or more optical modulation elements.

In each of the embodiments described above, the optical modulation element 243 is a transmissive liquid crystal panel in which the light incident surface and the light emitting surface are different. However, the present disclosure is not limited to this, and the optical modulation element 243 may be a reflective liquid crystal panel in which the light incident surface and the light emitting surface are the same. If the optical modulation element can modulate an incident light beam to form an image corresponding to image information, an optical modulation element other than liquid crystal, such as a device using a micromirror, for example, a digital micromirror device (DMD), may be adopted as the optical modulation element 243.

In each of the above-described embodiments, the vapor chambers 5A, 5B, 5C, 5D, 5E, and 5F constitute the wavelength conversion device 4A, 4E, and 4F, and the heat-generating body arranged in the placement region 524 of the vapor chambers 5A, 5B, 5C, 5D, 5E, and 5F is the fluorescent substance 41. However, the present disclosure is not limited thereto, and the heat-generating body provided in the placement region of the vapor chamber according to the present disclosure is not limited to the fluorescent substance and may be another heat-generating body such as a solid-state light emitting element or a semiconductor element.

In each of the embodiments described above, the electronic device including the cooling devices CDA, CDE, and CDF is exemplified as the projector 1 including the light source 31, the image forming device 24, and the projection optical device 26. However, the electronic device including the vapor chamber of the present disclosure is not limited to this and may be another electronic devices such as the information process device or the light source device.

### Summary of the Present Disclosure

Hereinafter, a summary of the present disclosure is appended.

### APPENDIX 1

A vapor chamber includes:
a thermally conductive first substrate with a placement region for a heat-generating body;
a thermally conductive second substrate facing the first substrate;
an accommodation chamber having an accommodation space formed by bonding a peripheral edge of the first substrate and a peripheral edge of the second substrate;
a working medium accommodated in the accommodation chamber and transitioning between a gas phase and a liquid phase by heating; and
a plurality of pillars arranged between a first inner surface of the first substrate and a second inner surface of the second substrate in the accommodation chamber, wherein
the first substrate has
   a first surface on a side opposite to the second substrate and,
   a recessed section recessed from the first surface,
a thickness dimension of the first substrate at a bottom section of the recessed section is smaller than a thickness dimension of the entire first substrate, and
the placement region is located at the bottom section of the recessed section.

According to this configuration, the thickness dimension of the placement region where the heat-generating body is placed on the first substrate is smaller than the thickness dimension of the peripheral portion of the recessed section on the first substrate. This allows the distance between the heat-generating body and the accommodation chamber to be shortened, making it easier to transfer the heat transmitted from the heat-generating body to the first substrate to the liquid phase working medium accommodated in the accommodation chamber. By this, the heat from the heat-generating body can easily convert the working medium in a liquid phase to the working medium in a gas phase, and the heat from the heat-generating body can be easily dissipated. Therefore, the cooling performance of the heat-generating body can be enhanced.

On the other hand, since the thickness dimension of the peripheral portion of the recessed section is larger than the thickness dimension of the bottom section of the recessed section, for example, when the heat-generating body is bonded to the placement region, it is possible to suppress expansion and deformation of the first substrate. Therefore, the pressure resistance of the vapor chamber can be maintained.

### APPENDIX 2

The vapor chamber according to appendix 1, wherein
the thickness dimension of the entire first substrate is between 0.8 mm and 2.0 mm inclusive, and
the thickness dimension of the first substrate at the bottom section of the recessed section is between 0.15 mm and 0.60 mm inclusive.

According to such a configuration, since the thickness dimension of the entire first substrate is within the above-described range, it is possible to secure the pressure resistance of the vapor chamber when the heat-generating body is bonded to the placement region. In addition, since the thickness dimension of the first substrate at the bottom section of the recessed section is a thickness dimension within the above-mentioned range, the efficiency of heat transfer from the heat-generating body to the working medium can be improved.

### APPENDIX 3

The vapor chamber according to appendixes 1 or 2, wherein
the first substrate has a corresponding region corresponding to the bottom section of the recessed section in the first inner surface and
the plurality of pillars includes peripheral pillars arranged around a peripheral edge of the corresponding region.

According to such a configuration, it is possible to secure the pressure resistance of the vapor chamber by the plurality of peripheral pillars provided corresponding to the peripheral edge of the corresponding region which may have a high temperature when the heat-generating body is bonded to the placement region.

### APPENDIX 4

The vapor chamber according to appendix 3, wherein
the plurality of peripheral pillars is arranged along an inner side of the peripheral edge of the corresponding region.

According to such a configuration, the plurality of peripheral pillars are arranged inside the peripheral edge of the corresponding region when viewed from the second substrate side with respect to the first substrate. For this reason, it is possible to suppress the deformation and the expansion of the vapor chamber at the peripheral edge of the corresponding region, that is, the peripheral edge of the recessed section, and to further increase the pressure resistance of the vapor chamber.

### APPENDIX 5

The vapor chamber according to appendix 3, wherein
the plurality of peripheral pillars is arranged along the outer side of the peripheral edge of the corresponding region.

According to such a configuration, the plurality of peripheral pillars are arranged the outer side of the peripheral edge of the corresponding region when viewed from the second substrate side with respect to the first substrate. For this reason, it is possible to suppress the deformation and the expansion of the vapor chamber at the peripheral edge of the corresponding region, that is, the peripheral edge of the recessed section, and to further increase the pressure resistance of the vapor chamber.

### APPENDIX 6

The vapor chamber according to appendix 3, wherein
the plurality of peripheral pillars is arranged spanning inside and outside the peripheral edge of the corresponding region.

According to such a configuration, the plurality of peripheral pillars is arranged spanning inside and outside the peripheral edge of the placement region when viewed from the first substrate side with respect to the second substrate. For this reason, it is possible to suppress the deformation and the expansion of the vapor chamber at the peripheral edge of the corresponding region, that is, the peripheral edge of the recessed section, and to further increase the pressure resistance of the vapor chamber.

### APPENDIX 7

The vapor chamber according to any one of appendixes 3 to 6, wherein
the pillars are arranged at regular intervals.

According to such a configuration, since the plurality of pillars is arranged at regular intervals, the pressure resistance can be maintained in the entire vapor chamber.

### APPENDIX 8

The vapor chamber according to any one of appendixes 3 to 6, wherein
the plurality of pillars includes
   inner pillars arranged within the corresponding region and
   outer pillars arranged outside the corresponding region and
a cross-sectional area of the inner pillar along the first inner surface at a portion at a first substrate side is smaller than a cross-sectional area of the outer pillar along the first inner surface at a portion at the first substrate side.

According to such a configuration, since the contact surface area between the inner pillar and the first inner surface can be reduced, it is possible to suppress the hindrance of the heat transfer from the first inner surface to the working medium in the liquid phase. Therefore, it is possible to suppress a decrease in the efficiency of heat transfer from the first substrate to the working medium in a liquid phase.

### APPENDIX 9

The vapor chamber according to any one of appendixes 1 to 8, further includes:
a first capillary force structure body that is provided on the first inner surface inside the accommodation chamber and that is configured to hold the liquid phase working medium.

According to such a configuration, the liquid-phase working medium can be easily supplied to the corresponding region to which the heat from the heat-generating body is transmitted. Therefore, the efficiency of heat transfer from the heat-generating body to the working medium can be enhanced, and the efficiency of cooling of the heat-generating body can be enhanced.

### APPENDIX 10

The vapor chamber according to appendix 8, further includes:
a first capillary force structure body that is provided on the first inner surface inside the accommodation chamber and that is configured to hold the liquid phase working medium, wherein
the inner pillars are bonded to the first inner surface while avoiding the first capillary force structure body.

According to such a configuration, the pillar can be directly joined to the first inner surface. Therefore, the bonding strength between the inner pillar and the first inner surface can be increased, and the pressure resistance strength of the vapor chamber can be further increased.

### APPENDIX 11

The vapor chamber according to appendix 8, further includes:
a first capillary force structure body that is provided on the first inner surface inside the accommodation chamber and that is configured to hold the liquid phase working medium, wherein
the inner pillars are bonded to the first inner surface via the first capillary force structure body.

According to such a configuration, since it is possible to suppress a decrease in the area of the first capillary force structure body due to the inner pillar, it is possible to suppress a decrease in the holding force and the transport force of the working medium in a liquid phase by the first capillary force structure body. Therefore, the working medium in a liquid phase can be efficiently transported to the corresponding region. By this, the efficiency of heat transfer from the heat-generating body to the working medium in a liquid phase can be enhanced.

### APPENDIX 12

The vapor chamber according to appendix 8, further includes:
a first capillary force structure body that is provided on the first inner surface inside the accommodation chamber and that is configured to hold the liquid phase working medium and
a second capillary force structure body that is provided on the second inner surface inside the accommodation chamber and that is configured to hold the liquid phase working medium wherein
one end of the inner pillars is bonded to the first inner surface while avoiding the first capillary force structure body and
an other end of the inner pillars is bonded to the second inner surface via the second capillary force structure body.

According to such a configuration, similarly to the above, the one end of the inner pillar can be directly joined to the first inner surface. Therefore, the bonding strength between the inner pillar and the first inner surface can be increased.

In addition, since a decrease in the area of the second capillary force structure body can be suppressed by the inner pillar, a decrease in the ability of the second capillary force structure body to retain and transport the liquid-phase working medium can be suppressed.

Therefore, the pressure resistance of the vapor chamber can be further increased, and the liquid-phase working medium can be efficiently transported toward the corresponding region, so that the efficiency of heat transfer from the heat source to the liquid-phase working medium can be increased.

### APPENDIX 13

A cooling device includes:
the vapor chamber according to any one of appendixes 1 to 12, and
the heat-generating body bonded to the placement region.

According to such a configuration, it is possible to configure a cooling device capable of suppressing expansion of the vapor chamber while cooling the heat-generating body.

### APPENDIX 14

An electronic device includes:
the cooling device according to appendix 13.

According to such a configuration, it is possible to achieve the same effect as that of the cooling device, and it is possible to configure an electronic device which can stably operate.

### APPENDIX 15

A wavelength conversion device includes:
the cooling device according to appendix 13, wherein
the heat-generating body is a fluorescent substance that converts the wavelength of incident excitation light and emits fluorescence and
the fluorescent substance is bonded to the placement region using heat conductive bonding materials.

According to such a configuration, since the fluorescent substance can be stably cooled, it is possible to configure a wavelength conversion device capable of stably emitting fluorescence.

### APPENDIX 16

A projector includes:
a light source;
the wavelength conversion device described in appendix 15, onto which light from the light source as the excitation light is incident;
an image forming device that creates image light from light including the fluorescence emitted by the fluorescent substance; and
a projection optical device that projects the image light.

According to such a configuration, it is possible to achieve the same effects as those of the wavelength conversion device described above, and it is possible to configure a projector that can operate stably.

What is claimed is:

1. A vapor chamber comprising:
a thermally conductive first substrate with a placement region for a heat-generating body;
a thermally conductive second substrate facing the first substrate;
an accommodation chamber having an accommodation space formed by bonding a peripheral edge of the first substrate and a peripheral edge of the second substrate;
a working medium accommodated in the accommodation chamber and transitioning between a gas phase and a liquid phase by heating; and
a plurality of pillars arranged between a first inner surface of the first substrate and a second inner surface of the second substrate in the accommodation chamber, wherein
the first substrate includes
a first surface on a side opposite to the second substrate and,
a recessed section recessed from the first surface,
a thickness dimension of the first substrate at a bottom section of the recessed section is smaller than a thickness dimension of the entire first substrate, and
the placement region is located at the bottom section of the recessed section.

2. The vapor chamber according to claim 1, wherein
the thickness dimension of the entire first substrate is between 0.8 mm and 2.0 mm inclusive, and
the thickness dimension of the first substrate at the bottom section of the recessed section is between 0.15 mm and 0.60 mm inclusive.

3. The vapor chamber according to claim 1, wherein
the first substrate has a corresponding region corresponding to the bottom section of the recessed section in the first inner surface and
the plurality of pillars includes peripheral pillars arranged around a peripheral edge of the corresponding region.

4. The vapor chamber according to claim 3, wherein
the plurality of peripheral pillars is arranged along an inner side of the peripheral edge of the corresponding region.

5. The vapor chamber according to claim 3, wherein
the plurality of peripheral pillars is arranged along the outer side of the peripheral edge of the corresponding region.

6. The vapor chamber according to claim 3, wherein
the plurality of peripheral pillars is arranged spanning inside and outside the peripheral edge of the corresponding region.

7. The vapor chamber according to claim 3, wherein
the pillars are arranged at regular intervals.

8. The vapor chamber according to claim 3, wherein
the plurality of pillars includes
inner pillars arranged within the corresponding region and
outer pillars arranged outside the corresponding region and
a cross-sectional area of the inner pillar along the first inner surface at a portion at a first substrate side is smaller than a cross-sectional area of the outer pillar along the first inner surface at a portion at the first substrate side.

9. The vapor chamber according to claim 1, further comprising:
a first capillary force structure body that is provided on the first inner surface inside the accommodation chamber and that is configured to hold the liquid phase working medium.

10. The vapor chamber according to claim 8, further comprising:
a first capillary force structure body that is provided on the first inner surface inside the accommodation chamber and that is configured to hold the liquid phase working medium, wherein
the inner pillars are bonded to the first inner surface while avoiding the first capillary force structure body.

11. The vapor chamber according to claim 8, further comprising:
a first capillary force structure body that is provided on the first inner surface inside the accommodation chamber and that is configured to hold the liquid phase working medium, wherein
the inner pillars are bonded to the first inner surface via the first capillary force structure body.

12. The vapor chamber according to claim 8, further comprising:
a first capillary force structure body that is provided on the first inner surface inside the accommodation chamber and that is configured to hold the liquid phase working medium and
a second capillary force structure body that is provided on the second inner surface inside the accommodation chamber and that is configured to hold the liquid phase working medium wherein
one end of the inner pillars is bonded to the first inner surface while avoiding the first capillary force structure body and
an other end of the inner pillars is bonded to the second inner surface via the second capillary force structure body.

13. A cooling device comprising:
the vapor chamber according to claim 1 and
the heat-generating body bonded to the placement region.

14. An electronic device comprising:
the cooling device according to claim 13.

15. A wavelength conversion device comprising:
the cooling device according to claim 13, wherein
the heat-generating body is a fluorescent substance that converts the wavelength of incident excitation light and emits fluorescence and
the fluorescent substance is bonded to the placement region using heat conductive bonding materials.

16. A projector comprising:
a light source;
the wavelength conversion device according to claim 15, onto which light from the light source as the excitation light is incident;
an image forming device that creates image light from light including the fluorescence emitted by the fluorescent substance; and
a projection optical device that projects the image light.
